(19) United States
(12) Patent Application Publication
(10) Pub. No.: US 2025/0311699 A1
(43) Pub. Date: Oct. 9, 2025

(54) BunBun Nail Basket

(71) Applicant: Sarah Lynn Sousa, Augusta, ME (US)

(72) Inventor: Sarah Lynn Sousa, Augusta, ME (US)

(21) Appl. No.: 18/445,650

(22) Filed: Dec. 11, 2023

(51) Int. Cl. A01K 13/00

(52) U.S. Cl. CPC A01K 13/007

(57) ABSTRACT

The BunBun Nail Basket is a pet grooming aid comprised of a cylindrical shaped cuff of varying natural and man made materials, natural pet safe edible materials that is open on one end, has netting attached on the other end, and is alternatively comprised of an open-ended cuff base, that is threaded at one end in the same manner as the mouth of a mason jar, and a detachable threaded lid with inserted netting.

### BACKGROUND

Many people fail to trim their pet's nails due to the oftentimes stressful nature of the task, the difficulty in working around the animal's paw hair, and possible anxiety issues of the pet, which can sometimes result in injury to either nail trimming participant, causing further anxiety and pet behavioral issues in future grooming situations.

Solution: The BunBun Nail Basket is placed over the top of the pet animal's paw and pushes the paw fur down and away from the nails of the paw, which presents the nail clearly for a much more safe nail trimming experience that alleviates anxiety and behavioral issues of both grooming participants.

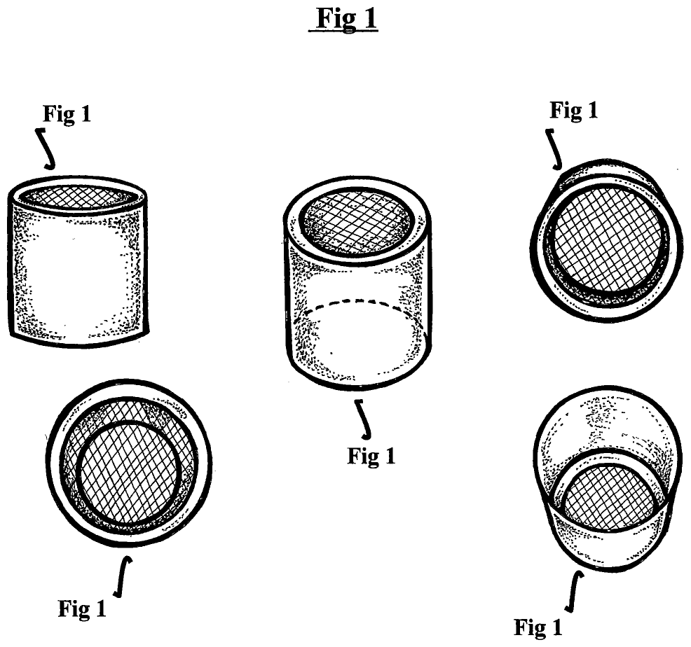

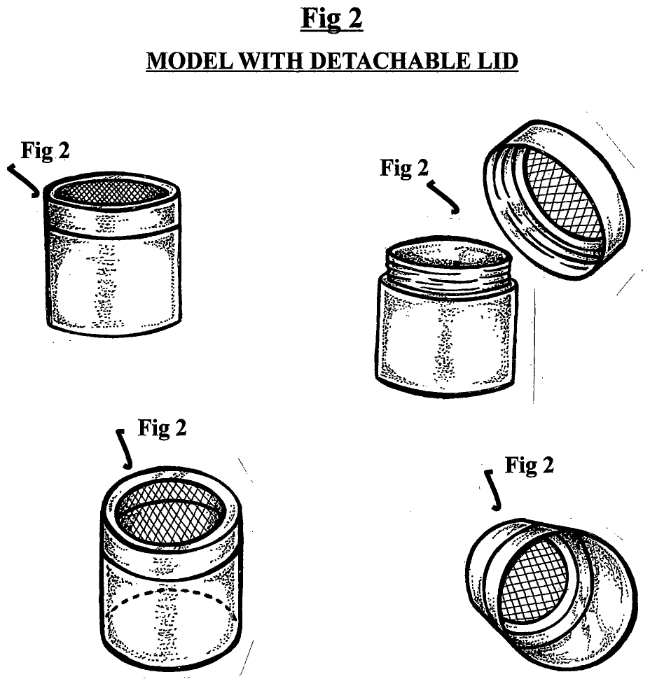

### FIG. 1, FIG. 2:

All units should be made of natural or actual compost-able/biodegradable materials that begin to break down following disposal, regardless of disposal technique or location, i.e.: landfills, which often prevent bio-plastics from being exposed to elements which aid in decomposition; water solubility and non-toxicity must play a factor:
Environmentally sound sugarcane bi-product (Bagasse)
Hemp and/or any similar applicable plant-based sources
Non-petrochemical biodegradable bio-based plastic-type materials including, but not limited to:
   Polyhydroxyalkanoates (PHAs)
   Polylactic acid (PLA)
   Thermoplastic polymer starch blends that are proven biodegradable
   Cellulose-based plastics
   Lignin-based polymer composites
   Polyglycolic acid (PGA)
   Polybutylene succinate (PBS)
   Polycaprolactone (PCL)
   Poly vinyl alcohol (PVA, PVOH)
   Polybutylene adipate terephthalate
Stainless steel base and lid for personal, veterinarian, pet salon or shelter environments for easy sterilization

### Edible Model

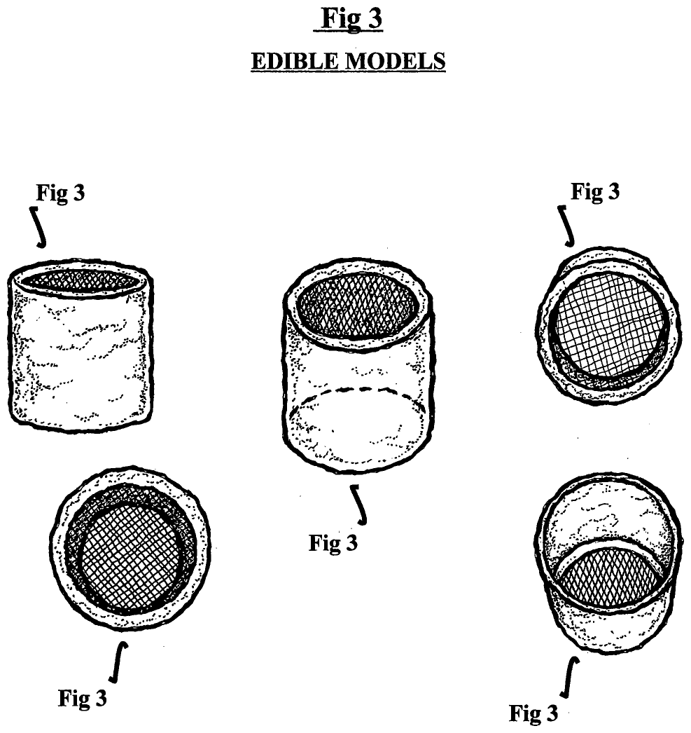

### FIG. 3:

Made from compressed Timothy Hay, other similar prarie grass or rodent/rabbit safe herbivore-edible fibrous plant with added ingredients such as potato starch for solidity and honey for flavor—can be a one-time use treat for good nail trimming experience and reward training tool for elimination of anxiety and fear during nail clipping.

1. An open-ended cylindrical cuff comprised of varying natural and man made materials with netting on one single end.

2. The cylindrical cuff of claim 1, comprised of an open-ended cuff base machine threaded on one end and a detachable open-ended machine threaded lid with insert-able disposable netting.

3. The cylindrical cuff of claim 1, entirely comprised of natural edible material.
